(19) United States
(12) Patent Application Publication
(10) Pub. No.: US 2004/0068585 A1
(43) Pub. Date: Apr. 8, 2004

(54) System and method for automatically transferring and sending an electronic document

(76) Inventors: Teng Hsu Lee, Taipei (TW); Yi-Mei Ting, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/449,415

(22) Filed: Jun. 2, 2003

(30) Foreign Application Priority Data
Aug. 27, 2002 (TW) 091119336

(51) Int. Cl. G06F 15/16

(52) U.S. Cl. 709/246

(57) ABSTRACT

A system and method for automatically transferring and sending an electronic document includes a plurality of databases located in different locations for collecting news data or information locally, with connections to each other through the Internet. The databases respectively include a transferring module, a synchronizing unit, a storing unit, a sending unit, and an editing/setting unit. The transferring module is used to transfer the encoding set of news data before being stored into a destination database. The encoding set transferring operation is performed according to the requirements of the database destination located, or to the encoding set that the database destination uses. The synchronizing unit is used to handle the data synchronizations among the plurality of databases. The storing unit is used to store data, while the editing/setting unit provides functions for editing an electronic newspaper and web pages by using the data stored in the storing unit. The sending unit provides functions for sending electronic newspapers to subscriber and for delivering news data among databases.

### BACKGROUND OF THE INVENTION

1. Field of the Invention

This invention generally relates to the field of sending an electronic document. More particularly, the present invention relates to a system and a method for automatically transferring and sending electronic documents.

2. Description of the Prior Art

The Internet deeply influences the transmitting and operating of information worldwide, and provides a common way for rapidly sending multi-media data. So far, various services are provided on the Internet, most popular being the WWW (World Wide Web), e-mail and BBS. Users directly read articles published on the WWW through a browser with multi-media interaction. The e-mail service is similar to the real world mail service. A user sends an e-mail to the receiver's mailbox through the Internet, and only the receiver who has the password and mail account is permitted to read the e-mail. No matter where the user is, the mail can be delivered in seconds, thus the convenience is changing the traditional way for people sending a message.

Therefore, in real world applications, e-mails can be the method and tool for people when subscribing to an electronic newspaper from the information provider. The electronic newspaper provides particular content that the user wants to know, thus the user can actively obtain the needed information by subscribing to a corresponding electronic newspaper, rather than the user searching for the needed information on the Internet. However, it will be a problem for the information provider, on how to transfer character encoding for different language versions of the electronic newspaper. Further, due to news happening in different locations, thus how the news and data is rapidly coordinated and sent will be a challenge needed to overcome.

Accordingly, the present invention provides a system and a method for automatically transferring and sending electronic documents, for increasing the speed of data collecting and newspaper editing. Besides, the news and data from different locations can be managed without the limitation of time and place. The present invention also simplifies the conventional flow of processing electronic documents to reach the purpose of reducing manpower.

### SUMMARY OF THE INVENTION

According to the shortcomings mentioned in the background, the present invention provides a system and a method for automatically transferring and sending electronic documents to improve the foregoing disadvantages.

Accordingly, the main object of the present invention is to provide a system and a method for automatically transferring and sending electronic documents and to increase the speed of data collecting and editing.

Another object of the present invention is to provide a system and a method for automatically transferring and sending electronic documents to assemble and dispatch data in different locations.

Another object of the present invention is to provide a system and a method for automatically transferring and sending electronic documents to simplify the flow of data management and process.

According to the objects mentioned above, the present invention provides a system and a method for automatically transferring and sending electronic documents, the system comprising, a plurality of databases located in different areas respectively for collecting data or information thereof, and the databases are coupled with each other through the Internet. Each database includes a transferring module, a synchronizing unit, a storing unit, a sending unit, and an editing/setting unit. The transferring module is used to transfer data encoding set according to the area that the individual database is located before the data is stored, or the data will be transferred accordingly to destination database's data encoding set. The synchronizing unit is used to handle data synchronization between the databases; the storing unit is used to store synchronized data after completing synchronization; the sending unit is used to send electronic documents to at least one subscriber, and for browsing web pages and searching for data stored in the storing unit through the Internet by external users. The editing/setting unit supports each administrator's database to manipulate the data stored in the storing unit, besides the database administrator uses a terminal to edit the electronic document and web page.

The method of the preferred embodiment of the present invention comprises the steps of first checking whether the data stored in the databases keep the newest consistent status. If the status of the data is inconsistent, then performing data synchronizations between the databases located in different locations to keep the data consistency among respective databases. Subsequently, proceeding the electronic newspapers editing job, the electronic newspaper can be that of various content or versions to fill the subscriber's requirements, after the editing job is finished, to set the time to be sent. Lastly, the electronic newspaper will be sent to subscriber's mailbox according to the subscriber's preference and setting. In the preferred embodiment of the present invention, a server has connections with the databases respectively, and the server may include the foregoing synchronizing unit, storing unit, editing/setting unit, browsing unit, and sending unit. Besides, the server further includes a terminal, which provides an operation interface for the administrator to manage and set the database. Accordingly, the present invention provides a system and a method for automatically transferring and sending electronic documents, increasing the speed of data processing, for managing data without the limitation of time and place, and for simplifying the flow of electronic document processing to reach the purpose of reducing manpower.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1a is the first preferred embodiment of system architecture of the present invention;

FIG. 1b is the second preferred embodiment of system architecture of the present invention;

FIG. 2 shows the function blocks of the system; and

FIG. 3 shows the flow chart of editing and sending an electronic newspaper.

### DESCRIPTION OF THE PREFERRED EMBODIMENT

The preferred embodiment of the invention will now be described in greater detail. Nevertheless, it should be noted that the present invention could be practiced in a wide range of other embodiments besides those explicitly described. The scope of the present invention is expressly not limited except as specified in the accompanying claims.

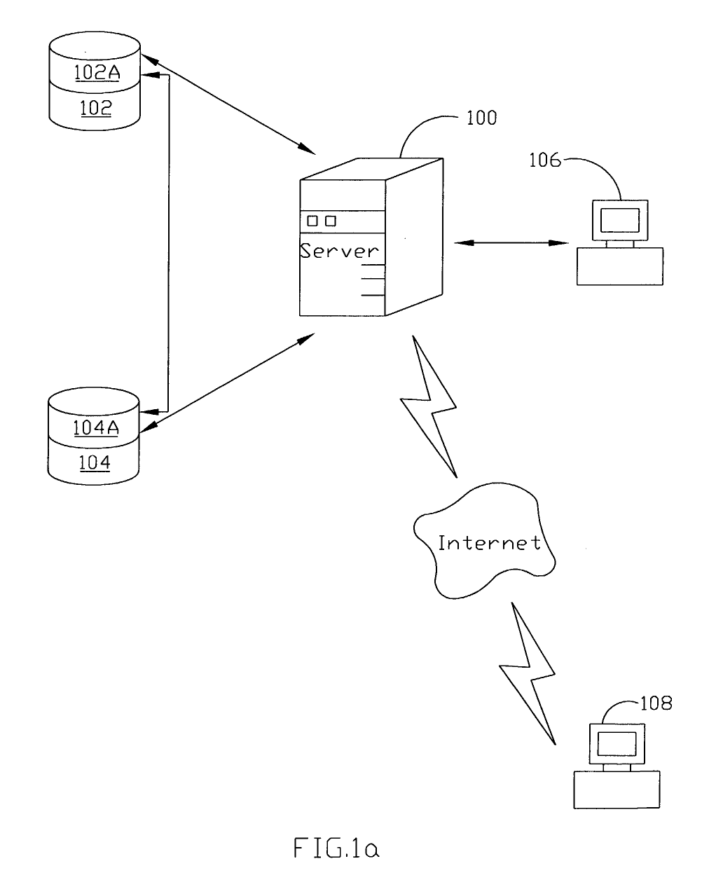

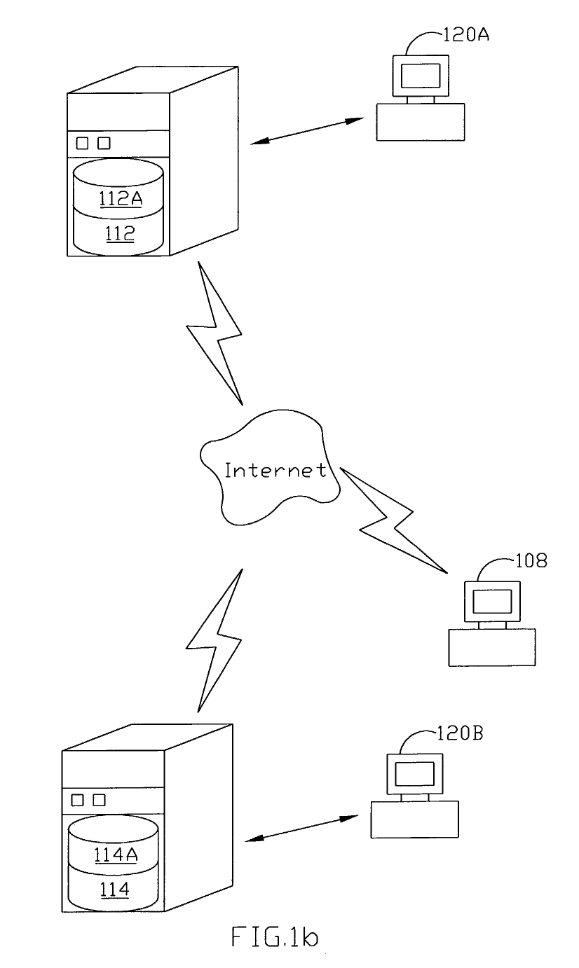

FIG. 1a is the first preferred embodiment of the system architecture of the present invention, for processing the electronic newspaper editing and sending from different locations. The first database 102 and the second database 104 are located at different locations, for storing and adding new news documents or other data respectively. The server 100 checks the first database 102 and the second database 104 for a predetermined time period, to confirm whether any new data is stored into the database 102 and 104. Thus, when the server 100 detects that the first database 102 and the second database 104 are updated, then the server 100 will perform data synchronization with the first database 102 and the second database 104. In other words, the server 100 checks the databases which are located at different locations at a predetermined time period, to keep data consistency among the databases; the first database 102 and the second database 104 can also perform data synchronization with each other to keep data consistency. The manner of data synchronization may directly perform between the first database 102 and the second database 104, or through the server 100 to keep the data consistently updated, besides, data synchronization can be immediately performed by the administrator. However, in other embodiments, the number of databases connected with the server 100 is not limited to two databases. The server 100 is allowed to connect to a plurality of databases directly or indirectly, and then the connections between the databases are established for data communication. Furthermore, any form of connection for communication, such as the Internet, WAN, LAN, or other type of network link up, can be used for data transmission, and among other databases.

However, the first database 102 and the second database 104 use different character encoding sets because the databases are located at different locations. For example, in the first preferred embodiment, the first database 102 is located in Taipei, and the second database 104 is located in Beijing, where the character encoding set used in respective locations is different. The electronic document data collected in Taipei will be stored in the first database 102 and encoded in the BIG5 character encoding set, the electronic document data collected in Beijing will be stored in the second database 104 and encoded in the GB character encoding set. Therefore, during the performance of the data synchronization, the database has to transfer the character encoding set of the received data before it can be stored into the database through a transferring module. In other words, the steps of data synchronization are in the order of; 1. data transmitting 2. encoding set transferring 3. stored into the database. Accordingly, the first transferring module 102A will transfer the synchronized data before the data is stored into the first database 102 located in Taipei. In the same way, the second transferring module 104A will transfer the synchronized data before the data can be stored into the second database 104 located in Beijing. This is done to make sure the stored data is encoded in the GB encoding set. Certainly, during data synchronization, the encoding set of the data can be transferred to match the encoding format used at the database destination. Then subsequently transmitting the data to related databases; finally being stored into databases, in other words, the steps of data synchronization will be in the order of; 1. encoding set transferring 2. data transmitting 3. stored into the database. For instance, if the data is stored in the second database 104 in Beijing, will transmit to the first database 102 in Taipei, through data synchronization. The encoding set of the data will be transferred from the simplified Chinese character encoding set (GB character encoding set) to the traditional Chinese character encoding set (BIG5 character encoding set) by the second transferring module 104A of the second database 104, then transmit and store the data into the first database 102. In practice, the job of transferring the encoded set can be performed by the database on the transmitting side or the database on receiving side. The user who is familiar with the skill of the present invention can select the way for implementation according to the real situation, however any equivalent modifications may be made without departing from what is intended to be limited solely by the appended claims.

According to the description mentioned above, the server 100 will keep the data consistency among databases via data synchronization operations. Therefore, the user can use an administrative terminal 106 of the server 100 to edit the electronic newspaper, thus the electronic newspaper could have various versions. For example, the traditional Chinese version, the simplified Chinese version or versions of different content for different subscribers. Therefore, the databases located in different areas can facilitate news collection, and then the news could be edited and sent by the server 100. Certainly, the server 100 can even complete automatic newspaper editing by the administrator's setting, and then finally the server 100 sends the completed newspaper to the subscriber. Additionally, the administrative terminal 106 is also used to set the synchronized timing between databases.

Furthermore, the administrative terminal 106 is also used to operate the server 100 for sending electronic newspapers. The electronic newspapers can be sent immediately or in accordance with a sending schedule. The server 100 sends the electronic newspaper to the subscriber's mailbox through the Internet in light of the e-mail address registered in advance. Besides, the content of electronic newspaper will be saved as a web page format and then stored inside the server 100 for general users to browse or search for specified content which they want among the newspaper archives. Therefore, the databases located at different locations can effectively collect news and manipulate it as well, thus the news becomes valuable data.

FIG. 1b is the second preferred embodiment of the system architecture of the present invention, wherein the first database 112 is located in Taipei, and the second database 114 is located in Beijing. The first database 112 and the second database 114 are used respectively to store electronic documents edited in the local area thereof, but the documents stored in the first database 112 are encoded in the traditional Chinese character encoding set (ex. BIG5 character encoding set), and the documents stored in the second database 114 are encoded in the simplified Chinese character encoding set (ex. GB character encoding set). As shown in FIG. 1b, the first database 112 and the second database 114 have data synchronization with each other through the Internet. During the foregoing data synchronization, when the databases receive synchronized data, firstly the character encoding set of the synchronized data must be transferred by a transferring module, subsequently storing it into the databases. Accordingly, when synchronized data is stored in the first database 112 located in Taipei, the first transferring module 112A first must transfer the character encoding set. In the same way, when synchronized data is stored to the second database 114 located in Beijing, the transfer character encoding set must be sent through the second transferring module 114A to make sure the data stored inside the second database 114 is encoded in the simplified Chinese character encoding set, like the GB character encoding set.

Certainly, when the first database 112 and the second database 114 are proceeding with data synchronization, the first transferring character encoding set by the transferring module in a source database, then transmitting it to a destination database and finally storing it. For example, a new entry data is to be synchronized from the first database 112 (source database), Taipei to the second database 114 (destination database), Beijing. The encoding set of the data can be firstly transferred by the first transferring module 112A, for transferring the encoding set to GB character encoding set of the simplified Chinese character, then transmitting it to the second database 114 for storage. In the same way, new data entry is to be synchronized from the second database 114, in Beijing to the first database 112, in Taipei. The encoding set of the data can be firstly transferred by the second transferring module 114A, for transferring the encoding set to traditional Chinese character encoding set (BIG5 character encoding set), then transmitting it to the first database 112 for storage.

In another way, each administrator of the database can edit the traditional Chinese version electronic newspapers or simplified Chinese version by using the document stored in the first database 112 or the second database 114, and then according to the subscriber's subscription, send the preferred electronic newspaper to the subscriber 118 through the Internet. Certainly, the administrators can manipulate the sending scheduling and synchronized timing of the database through the administrative terminal 120A or 120B.

Moreover, the first database 112 (or 102) stored the traditional Chinese news data, and the second database 114 (or 104) stored the simplified Chinese news data, can be further separated to several sub-databases. Each sub-database may respectively synchronize with the first database 112 (or 102), and the second database 114 (or 104), after that the first database 112 (or 102) or the second database 114 (or 104) may have further synchronization with each other. For instance, the first database 112 (or 102) located in Taipei can further control the sub-databases located in Hsin-zhu or Gao-Xiong, and the second database 114 (or 104) located in Beijing can further control the sub-databases located in Shang-Hai or Shen-Zhen for necessary management. Herein, the sub-databases located in Hsin-zhu or Gao-Xiong may have synchronization with the first database 112 (or 102) first. The sub-databases located in Shang-Hai or Shen-Zhen may have synchronization with the first database 114 (or 104) first. Then the first database 112 (or 102) and the second database 114 (104) can perform data synchronization with each other. Besides, within real implementation, all databases can be treated equally without discrimination, whether they are located in Taipei, Hsin-zhu, Gao-Xiong, Beijing, Shang-Hai, or Shen-Zhen, they can synchronized at the same time. In fact, synchronization operation of the database is a familiar skill known in the field of the present invention, however any equivalent modifications may be made without departing from what is intended to be limited solely by the appended claims.

According to the embodiments mentioned above, we presume a possible scenario, when the following text is encoded by BIG5 character encoding set, and stored in the first database 112 (or 102) in Taipei is:

[symbol] [symbol] PC [symbol] [symbol] [symbol] [symbol] [symbol] [symbol] [symbol] [symbol] WLAN [symbol] GPRS, CMDA [symbol] (RF) [symbol] (BASEBAND) [symbol] WLAN [symbol] [symbol] [symbol] [symbol] [symbol] [symbol] . . .

[symbol]

Furthermore,,when the following text that encoded by GB character encoding set, and stored in the second database 114 (or 104) in Beijing is:

[symbol] [symbol] P4PB 266E [symbol] P4 [symbol] P4X266E [symbol] [symbol] P4X266E [symbol] P4PB 266E [symbol] Intel P4 [symbol] [symbol] 533 MHz [symbol] [symbol] [symbol] APG 4X, DDR 266, USB 2.0 [symbol] ATA 133ₒ . . .

[symbol]

Next, the news data stored in Taipei and Beijing will be collected at the server through data synchronization, and then be edited to an electronic newspaper, the subscriber who subscribes to the traditional Chinese version (BIG5 character encoding set) will obtain the newspaper similar to the following:

[symbol] [symbol] PC [symbol] [symbol] [symbol] [symbol] [symbol] [symbol] [symbol] [symbol] WLAN [symbol] GPRS, CDMA [symbol] (RF) [symbol] (Baseband) [symbol] WLAN [symbol] [symbol] [symbol] [symbol] [symbol] . . .

[symbol]

[symbol] [symbol] P4PB 266E [symbol] [symbol] P4X266E [symbol] P4X266E [symbol] P4PB 266E [symbol] Intel P4 [symbol] [symbol] 533 MHz [symbol] [symbol] AGP 4X, DDR 266 USB 2.0 [symbol] ATA 133ₒ . . .

[symbol]

And the subscriber who subscribes to the simplified Chinese version (GB character encoding set) will obtain the newspaper similar to the following:

[symbol] [symbol] PC [symbol] [symbol] [symbol] [symbol] [symbol] [symbol] [symbol] WFLAN [symbol] GPRS, CDMA [symbol] (RF) [symbol] (BASEBAND) [symbol] WLAN [symbol] [symbol] [symbol] [symbol] [symbol] . . .

[symbol]

[symbol] P4PB 266E [symbol] P4 [symbol] P4X266E [symbol] P4X266E [symbol] P4PB 266E [symbol] Intel P4 [symbol] [symbol] 533 MHz [symbol] [symbol] AGP 4X, DDR 266, USB 2.0 [symbol] ATA 133ₒ . . .

[symbol]

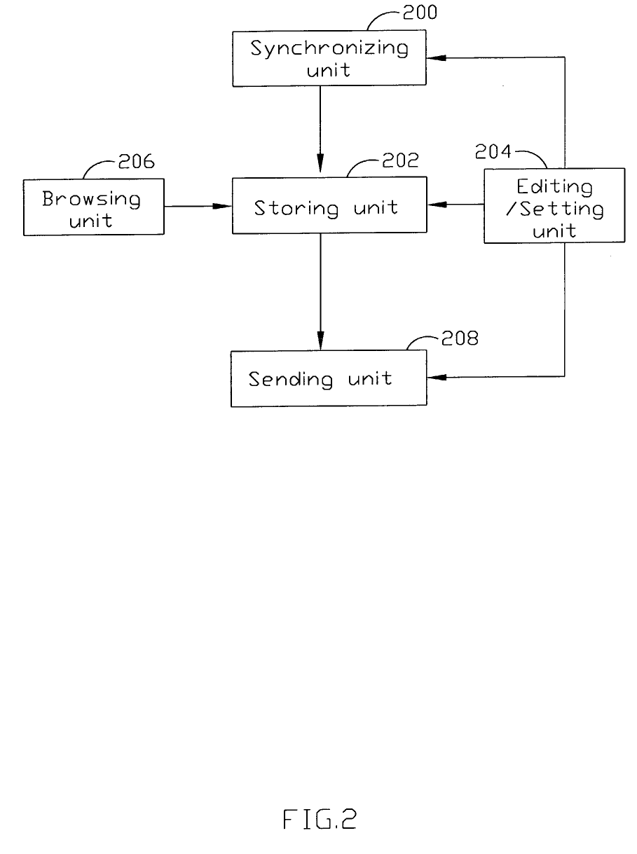

FIG. 2 shows the system function blocks for performing the data synchronization, which may be embedded in the server 100 as shown in FIG. 1 (the first preferred embodiment), or respectively embedded in the first database 112 and the second database 114 (the second preferred embodiment). As shown in FIG. 2, the synchronizing unit 200 is used to handle data synchronization operations between databases located at different locations, which encompasses operations of delivering synchronized news data and storing the synchronized data in a storing unit 202. The editing/setting unit 204 provides functions for editing electronic newspapers and web pages by using the data stored in the storing unit 202. A user may read or search the archives of the electronic newspapers stored in the storing unit 202 via the aid of a browsing unit 206. The editing/setting unit 204 also supports functions for planning the sending schedule of the sending unit 208, so that the sending unit 208 can send the electronic newspapers to subscribers based on the planned schedule. Furthermore, the editing/setting unit 204 can be used to set the synchronizing unit 200 (for example, to set the interval between two continuous data synchronization operations). In the second preferred embodiment, the storing unit 202 may provide functions for storing non-synchronized news data as long as the non-synchronized and synchronized news data can be easily recognized.

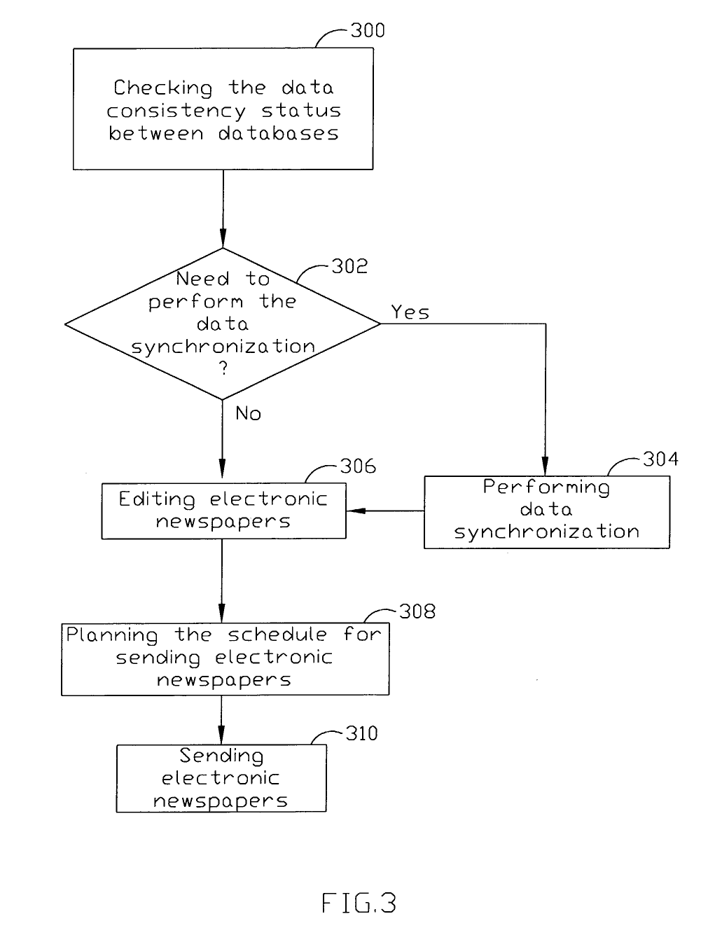

FIG. 3 illustrates the flow chart for editing and sending the electronic newspaper. Firstly, the consistency of the new data stored in the databases is checked in block 300. A data synchronization operation is performed when there are non-synchronized news data in databases from block 302 to 304. Please note that any news data should be transferred by using a character encoding set appropriate for a destination database before being stored. However, the character transferring operations can be performed at original or destination databases. Next, an operation of editing the electronic newspapers can be performed to derive various versions or contents according to different subscriber's requirements (for example, according to the subscriber's priority (e.g., a subscriber is a member or not)) in block 306. Thereafter, the schedule for delivering electronic newspapers may be assigned in block 308 after the editing operation is done. Please note that the electronic newspapers can be delivered immediately after the editing operation is finished or delivered by the assigned schedule, which indicates that the deliveries of the electronic newspapers will not be limited by time. Finally, the server sends electronic newspaper to each subscriber's mailbox in light of the versions or requirements he/she made in block 310.

In order to eliminate the aforementioned disadvantages of the conventional electronic newspapers transferring and sending approach, the present invention provides a system and a method for transferring and sending electronic newspapers so that the collections and editing performances of news data can be significantly upgraded. Furthermore, those news data come from different locations can be managed regardless the spatial and temporal limitations. Not only processes for manipulating the electronic newspapers can be significantly simplified so as to achieve the purpose of manpower simplification, but also deliver subscriber electronic newspapers including substantially the same contents but encoded by different character encoded sets.

Although specific embodiments have been illustrated and described, it will be obvious to those skilled in the art that various modifications may be made without departing from what is intended to be limited solely by the appended claims.

What is claimed is:

1. A system for automatically sending electronic newspapers, said system comprising:
a plurality of databases located in different locations respectively for collecting news data thereof, wherein said news data is transferred according to character encoding sets of a destination database before being stored into said destination database; and
a server connecting with said plurality of databases for performing data synchronization operations to keep data consistency among said plurality of databases, wherein said electronic newspapers are delivered to a subscriber after said data synchronization operations being performed to make sure electronic newspapers which said server delivers substantially include the same contents.

2. The system according to claim 1, wherein said plurality of databases are respectively located in locations use a traditional Chinese character encoding set or a simplified Chinese character encoding set for collecting local news thereof.

3. The system according to claim 2, wherein each one of said plurality of databases has a transferring module for performing said character encoding set transferring operations.

4. The system according to claim 2, wherein a plurality of said electronic newspapers are encoded by said traditional Chinese character encoding set and a plurality of said electronic newspapers are encoded by said simplified Chinese character encoding set.

5. The system according to claim 4, wherein said plurality of electronic newspapers encoded by said traditional Chinese character encoding set and said plurality of electronic newspapers encoded by said simplified Chinese character encoding set substantially include the same contents.

6. The system according to claim 1, wherein said data is transferred according to a character encoding sets of said destination database at an original database or at said destination database.

7. The system according to claim 1, wherein said server comprises a synchronizing unit for handling said data synchronization operations among said plurality of databases.

8. The system according to claim 1, further comprising an editing/setting unit providing functions of editing various versions and contents of said electronic newspapers according to a subscriber requirements.

9. A system for transferring and sending an electronic newspaper encoded by a traditional Chinese version or a simplified Chinese version, said system comprising:
a first database for storing a news data encoded by a traditional Chinese character coding set and for sending an electronic newspaper encoded by using said traditional Chinese character coding set; and
a second database for storing a news data encoded by using said simplified Chinese character coding set;
wherein said first database and said second database respectively includes a synchronizing unit for synchronizing said news data between said first database and said second database to make sure electronic newspapers which deliver by said first database and said second database substantially include the same contents.

10. The system according to claim 9, wherein said first database comprises a traditional Chinese character transferring module for transferring a character encoding set of said news data to said traditional Chinese character encoding set.

11. The system according to claim 9, wherein said first database comprises a simplified Chinese character transferring module for transferring a character encoding set of said news data to said simplified Chinese character encoding set before delivering said news data to said second database.

12. The system according to claim 9, wherein said second database comprises a simplified Chinese character transferring module for transferring a character encoding set of said news data to said simplified Chinese character encoding set.

13. The system according to claim 9, wherein said second database comprises a traditional Chinese character transferring module for transferring a character encoding set of said news data to said traditional Chinese character en-coding set before delivering said news data to said first database.

14. The system according to claim 9, wherein said first database and said second database individually comprises a sending unit for sending said electronic newspaper to a subscriber.

15. The system according to claim 14, further comprising an editing/setting unit for editing contents of said electronic newspaper according to requirements of a subscriber.

16. A method for automatically sending electronic newspapers, said method comprising the steps of:
checking a data synchronization consistency among a plurality of databases;
transferring a character encoding set of a synchronized news data according to a location of a destination database when data synchronization among said databases is hold;
storing said synchronized news data into said destination database after the character encoding set of said synchronized news data is transferred; and
sending said electronic newspapers to a subscriber.

17. The method according to claim 16, wherein said plurality of databases are located in locations for collecting news data locally, wherein news data are encoded by a traditional Chinese character encoding set and a simplified Chinese character encoding set.

18. The method according to claim 16, wherein each one of said plurality of database comprises a transferring module for transferring said character encoding set.

19. The method according to claim 18, wherein said encoding set transferring operation is performed at an original database before delivering said news data to a destination database.

20. The method according to claim 18, wherein said encoding set transferring operation is performed at a destination database after said news data are delivered from an original database.
